(19) United States
(12) Patent Application Publication
(10) Pub. No.: US 2007/0137710 A1
(43) Pub. Date: Jun. 21, 2007

(54) Swiveling overhead air supply

(76) Inventor: Bryan Bunting, Columbus, OH (US)

Correspondence Address: BUTZER & CHEN LAW, LLC, 870 HIGH STREET, SUITE 104, WORTHINGTON, OH, 43085, US

(21) Appl. No.: 11/303,415

(22) Filed: Dec. 16, 2005

(51) Int. Cl. F16L 5/00

(52) U.S. Cl. 137/357

(57) ABSTRACT

A swiveling overhead air supply for an air powered tool, including at least a mounting structure, a swivel attached to or incorporated into the mounting structure, an arm attached to the swivel, and an air line or air line connector attached to or extending from the arm. The air line or air line connector preferably is located at or near an end of the arm opposite the swivel. In a preferred embodiment, the mounting structure mounts to a ceiling, a beam in the ceiling, a wall, or a beam in the wall. Also, a method of using the swiveling overhead air supply to provide an air supply for an air powered tool.

### BACKGROUND OF THE INVENTION

1. Field of the Invention

This invention relates to a swiveling overhead air supply.

2. Description of the Related Art

Air supplied through air lines can be used to power tools such as impact wrenches and air hammers. These tools are used in a great many settings, from manufacturing to vehicle service.

The air lines typically are mounted at a fixed position. Sometimes the air lines are mounted near a floor, sometimes at a ceiling. In these cases, maneuvering an air line around a work area can be problematic. The air line can hit or rub against other items in the work area, for example a car or vehicle, and can damage or knock over those items. Even if care is used, maneuvering the air line around the work area adds to an amount of time needed to perform any given task using an air powered tool.

In addition, even when an air powered tool is not being used, the air line can be in an inconvenient place. The air line can create a safety hazard, for example a tripping hazard.

One partial solution is to mount the air line in a retracting housing so that the air line retracts out of the way when not being used. However, this partial solution does not address problems associated with maneuvering an air line around a work area when an air powered tool is being used.

### SUMMARY OF THE INVENTION

One embodiment of the invention is a swiveling overhead air supply for an air powered tool, including at least a mounting structure, a swivel attached to or incorporated into the mounting structure, an arm attached to the swivel, and an air line or air line connector attached to or extending from the arm. The air line or air line connector preferably is located at or near an end of the arm opposite the swivel. A result of this arrangement is that the air line can be more easily maneuvered around a work area.

In a preferred embodiment, the mounting structure mounts to a ceiling, a beam in the ceiling, a wall, or a beam in the wall. Examples of a suitable mounting structure include, but are not limited to, the following: at least one plate and one or more bolts that bolt the plate to the ceiling, the beam in the ceiling, the wall, or the beam in the wall; at least one clamp that clamps to the ceiling, the beam in the ceiling, the wall, or the beam in the wall; and at least one U-bolt that bolts to the ceiling, the beam in the ceiling, the wall, or the beam in the wall.

The swivel preferably includes a bearing housing within a sleeve and one or more bearings and/or bushings that permit the bearing housing to rotate within the sleeve. Other types of swivels can be used.

The arm can be any length, but at least a three foot or six foot length is preferred.

In some embodiments, air flows through the swivel, the arm, or both to the air line or air line connector. In other embodiments, air flows through an air line that can be wholly or partially internal or external to the swiveling overhead air supply.

In preferred embodiments, a retracting housing is attached to the arm. This retracting housing is for the air line or for an external air line attached to the air line connector. Alternatively, the air line or external air line can simply hang down or extend from the arm.

The invention also encompasses methods of using the swiveling overhead air supply to supply air to a power tool.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows an embodiment of a swiveling overhead air supply that mounts to a ceiling.

FIG. 2 shows a top view of a mounting plate for the swiveling overhead air supply shown in FIG. 1.

FIG. 3 shows another embodiment of a mounting structure for a swiveling overhead air supply that mounts to a ceiling.

FIG. 4 shows another embodiment of a swiveling overhead air supply with additional support for an extended arm.

FIGS. 5 and 6 show embodiments of a swiveling overhead air supply that can be mounted on a beam, for example above a ceiling or in a wall, or to the wall itself.

FIGS. 7 to 9 show embodiments of a swiveling overhead air supply that include a retracting housing for an air line.

### DESCRIPTION OF THE PREFERRED EMBODIMENTS

Briefly, one embodiment of the invention is a swiveling overhead air supply for an air powered tool, including at least a mounting structure, a swivel attached to or incorporated into the mounting structure, an arm attached to the swivel, and an air line or air line connector attached to or extending from the arm. The term “attached” encompasses both attached directly and attached indirectly through another structure. The air line or air line connector preferably is located at or near an end of the arm opposite the swivel. The air line is “near” an end of the arm if it is located at a last tenth of the arm. The arm can be any length, but at least a three foot or six foot length is preferred. In some embodiments, air flows through the swivel, the arm, or both to the air line or air line connector. In other embodiments, air flows through an air line that can be wholly or partially internal or external to the swiveling overhead air supply.

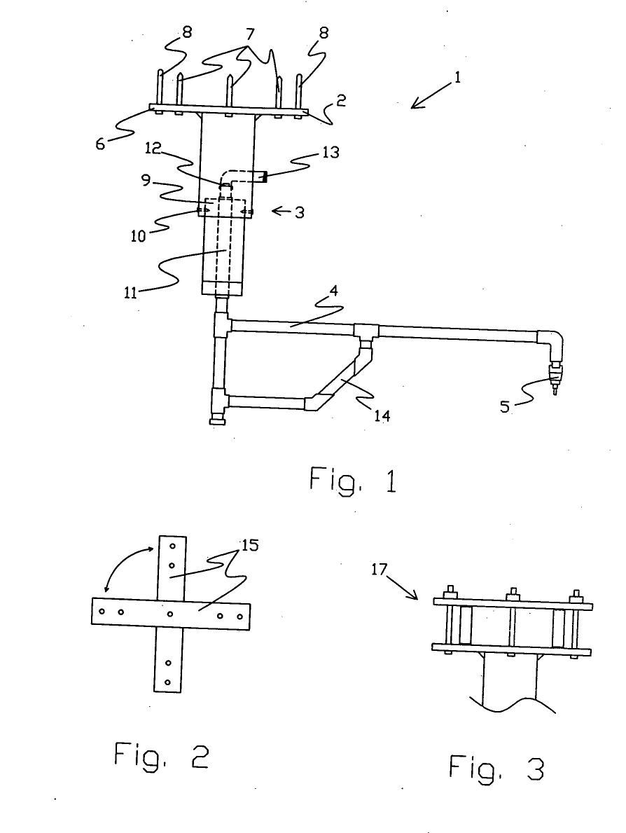

FIG. 1 shows an embodiment of such a swiveling overhead air supply that mounts to a ceiling. Overhead air supply 1 includes mounting structure 2, swivel 3, and arm 4 attached (indirectly) to swivel 3. Air line connector 5 for an air line for a power tool is attached at an end of arm 4 opposite swivel 3.

Mounting structure 2 in FIG. 1 includes plate 6 that is disposed to be bolted with bolts 7 to a ceiling or a beam in the ceiling. The term “beam” encompasses any beam, stud, joist, or any other suitably sized piece of wood, steel, or other material. Three eighths inch diameter bolts are preferred, although other sizes of bolts can be used. Alternatively, U-bolts 8 fastened over one or more beams in the ceiling or other types of fasteners can be used. In some embodiments, plural types of fasteners (e.g., both bolts and U-bolts) can be used.

As shown in FIG. 1, swivel 3 includes a bearing housing 9 with one or more bearings (hidden) and/or bushings (hidden) that permit an extension 11 attached to arm 4 to swivel within the bearing housing. Set screws 10 can be provided for securing the bearing housing. The swivel also includes a swiveling coupling 12 between extension 11 and air intake 13. Other types of swivels and swiveling arrangements can be used besides the arrangement shown in FIG. 1.

In FIG. 1, air is supplied through air intake 13, for example from an air compressor or other air source, and flows into extension 11, through arm 4, and to air line connector 5. The air intake can include any suitable connection for an air line, for example a poly tubing connector, pipe nipple (shown), pipe tee, or air line connector.

In this embodiment, arm 4 and extension 11 preferably are airtight, for example made of copper or PVC pipe, T-fittings, and 45 degree elbows of the type used in plumbing. One inch diameter pipe is suitable, but other sizes of pipe can be used. Furthermore, other designs of arms and extensions made from other materials can be used.

Bottom portion 14 of arm 4 provides extra rigidity and support to the arm. In some embodiments, this bottom portion is omitted or a different type of support is used.

FIG. 2 shows a top view of a mounting plate for the swiveling overhead air supply shown in FIG. 1. The double headed arrow in FIG. 2 illustrates that this part of the mounting plate is formed of two parts 15 that can fold together. This facilitates easy installation, for example between closely spaced beams in a ceiling. Once inserted between the beams, the parts can be unfolded to form a secure mounting.

FIG. 3 shows another embodiment of a mounting structure for a swiveling overhead air supply that mounts to a ceiling. This mounting structure is a clamp 17, in this case two plates and bolts, that clamps to a beam in the ceiling.

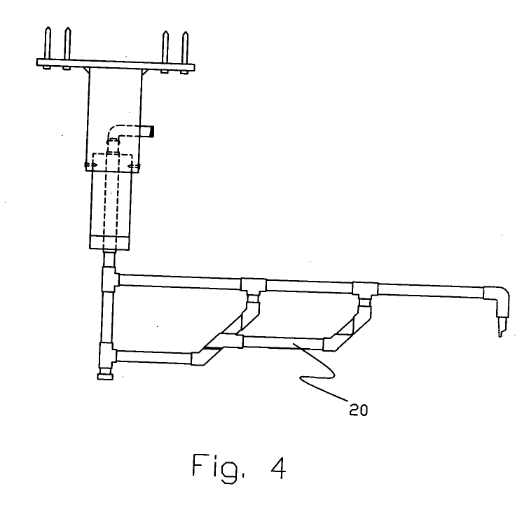

FIG. 4 shows another embodiment of a swiveling overhead air supply with additional support for an extended arm. This swiveling overhead air supply includes an additional bottom portion 20 that provides additional rigidity and support to the arm.

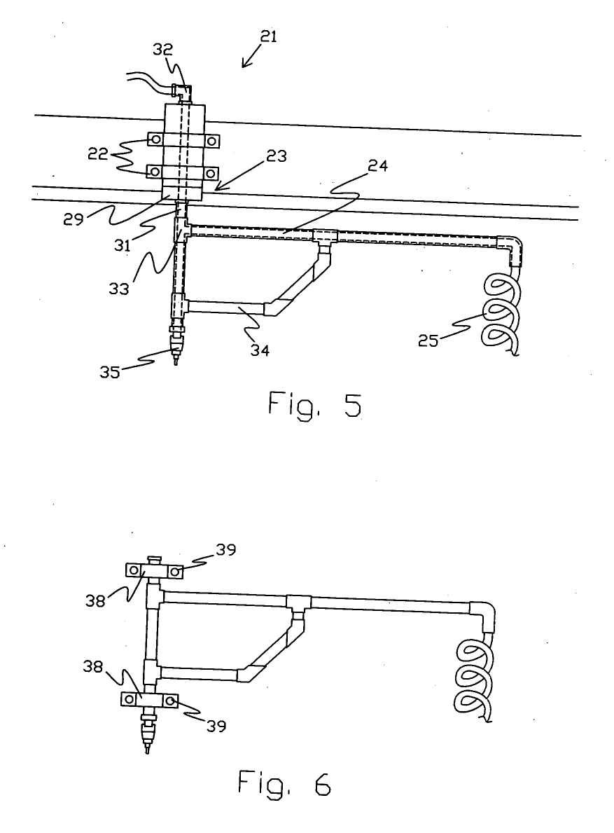

FIG. 5 shows an embodiment of a swiveling overhead air supply that can be mounted on a beam, for example above a ceiling or in a wall, or to the wall itself.

Overhead air supply 21 includes mounting structure 22, swivel 23, and arm 24 attached (indirectly) to swivel 23. Air line 25 for a power tool hangs down or extends from an end of arm 24 opposite swivel 23.

Mounting structure 22 in FIG. 5 includes clamps that are disposed to be bolted or otherwise attached to a beam, for example above a ceiling or in a wall, or to the wall itself. Copper tubing clamps are well suited for this embodiment, although other types of clamps can be used. Again, the term “beam” encompasses any beam, stud, joist, or any other suitably sized piece of wood, steel, or other material.

As shown in FIG. 5, swivel 23 includes a bearing housing 29 with one or more bearings (hidden) and/or bushings (hidden) that permit an extension 31 attached to arm 24 to swivel within the bearing housing. The swivel also includes a swiveling coupling between extension 31 and air intake 32. Other types of swivels and swiveling arrangements can be used besides the arrangement shown in FIG. 5.

In FIG. 5, air is supplied through air intake 32, for example from an air compressor or other air source, and flows into internal air line 33. The air intake can include any suitable connection for an air line, for example a poly tubing connector (shown), pipe nipple, pipe tee, or air line connector.

The internal air line runs through extension 31 and arm 24 to air line 25. In some embodiments, internal air line 33 and air line 25 comprise one air line. In other embodiments, these are separate air lines that are joined, for example at an end of arm 24.

Because an internal air line is used, arm 24 and extension 31 need not be air tight. However, they can be air tight to provide an additional seal for air flowing through the swiveling overhear air supply. Arm 24 and extension 31 can be made, for example, from copper or PVC pipe, T-fittings, and 45 degree elbows of the type used in plumbing. One inch diameter pipe is suitable, but other sizes of pipe can be used. Furthermore, other designs of arms and extensions made from other materials can be used.

Bottom portion 34 of arm 24 provides extra rigidity and support to the arm. In some embodiments, this bottom portion is omitted.

Internal air line 33 in FIG. 5 branches to air line connector (i.e., fitting) 35, thereby providing a convenient attachment for an additional air line for use with air powered tools.

FIG. 6 shows some possible variations on the swiveling overhead air supply shown in FIG. 5. First, instead of using bearing housing 29, this air supply uses pillow block bearings 38 with clamps 39, thereby incorporating the swivel into the mounting structure. Second, two clamps are used, for example for attaching the overhead air supply to a wall. Third, no internal air line is used in the embodiment shown in FIG. 6. Thus, the arm and extension should be airtight with the air intake.

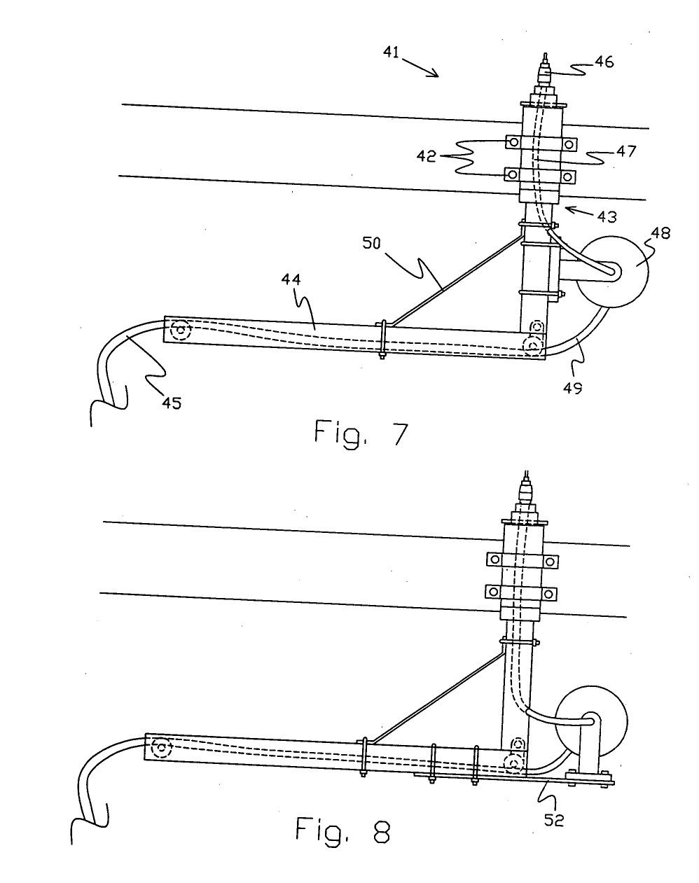

FIGS. 7 to 9 show embodiments of a swiveling overhead air supply that include a retracting housing for an air line. These figures also illustrate a different arrangement for supporting the arm of the air supply.

In FIG. 7, overhead air supply 41 includes mounting structure 42, swivel 43, and arm 44 attached to swivel 43. Air line 45 for a power tool extends from an end of arm 44 opposite swivel 43.

Air is supplied through air intake 46, for example from an air compressor or other air source, and flows into air line 47. The air intake can include any suitable connection for an air line, for example a poly tubing connector, pipe nipple, pipe tee, or air line connector (shown).

Air line 47 in FIG. 7 runs to retracting housing 48 for air line 45, which runs through arm 44 and out at or near an end of the arm. Thus, air flows from air intake 46 to air line 45. The retracting housing can retract air line 45 to get the air line out of the way when not in use.

The retracing housing is attached to the swiveling overhear air supply by U-bolts in FIG. 7. Other techniques for attaching the retracting housing to the air supply can be used, for example welding.

The embodiment shown in FIG. 7 also includes support brace 50 for arm 44. In the figure, support brace 50 is attached to the swiveling overhead air supply using U-bolts. Other techniques for attaching the brace to the air supply can be used, for example welding. In some embodiments, if the arm is sufficiently strong, no such bracing is needed.

FIG. 8 shows one possible variations on the swiveling overhead air supply shown in FIG. 7. In this variation, the retracting housing is attached using a support plate 52 that is in turn attached to the arm, for example through U-bolts.

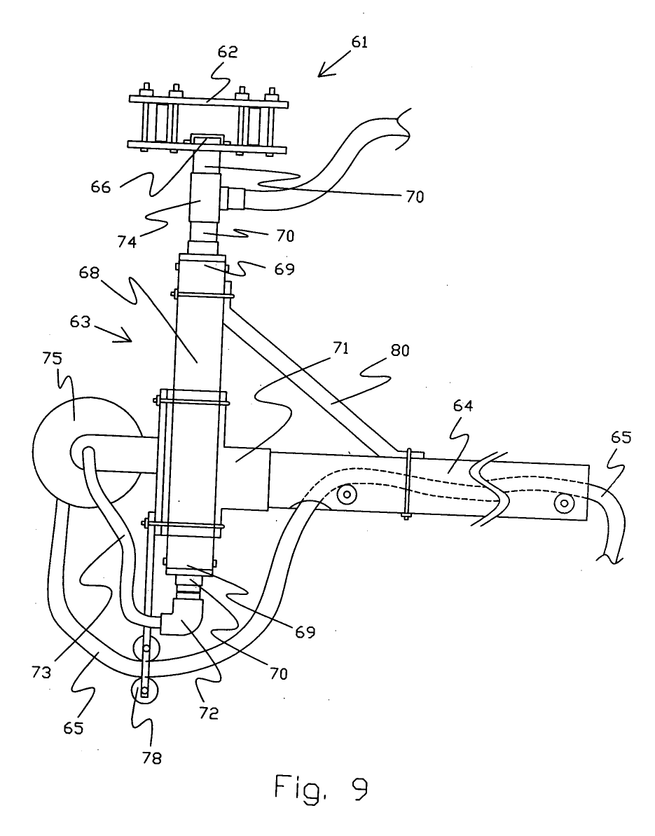

FIG. 9 show another embodiment of a swiveling overhead air supply that includes a retracting housing for an air line.

Overhead air supply 61 includes mounting structure 62, swivel 63, and arm 64 attached to swivel 63. Air line 65 for a power tool extends from an end of arm 64 opposite swivel 63.

Mounting structure 62 in FIG. 9 is a clamp that clamps to a beam in the ceiling. The mounting structure is assisted by a cap and washer 66 that provides extra support for the swiveling overhead air supply.

As shown in FIG. 9, swivel 63 includes a bearing housing 68 with one or more bearings 69 (hidden) and/or bushings (hidden). The bearing housing swivels about extension 70 from the mounting structure. Set screws can be provided for securing the bearing housing. The bearing housing is attached to arm 64 through sleeve 71, thereby permitting the arm to swivel about extension 70. The swivel also includes a swiveling coupling in extension 70 just above the bearing housing and a swiveling coupling between extension 70 and an attachment 72 for air line 73.

In FIG. 9, air is supplied through air intake 74, for example from an air compressor or other air source, and flows into extension 70 to air line 73. The air intake can include any suitable connection for an air line, for example a poly tubing connector, pipe nipple, pipe tee (shown), or air line connector.

Air line 73 in FIG. 9 runs to retracting housing 75 for air line 65, which runs through arm 64 and out at or near an end of the arm. Thus, air flows from air intake 74 to air line 65. The retracting housing can retract air line 65 to get the air line out of the way when not in use. Wheels 78 in FIG. 9 help to guide the air line when it is being retracted or pulled out for use.

The retracing housing is attached to the swiveling overhear air supply by U-bolts in FIG. 9. Other techniques for attaching the retracting housing to the air supply can be used, for example welding.

The embodiment shown in FIG. 9 also includes support brace 80 for arm 64. In the figure, support brace 80 is attached to the swiveling overhead air supply using U-bolts. Other techniques for attaching the brace to the air supply can be used, for example welding. In some embodiments, if the arm is sufficiently strong, no such bracing is needed.

In one embodiment, arm 64 is 2″ copper tubing, bearing housing 68 is made of 2″ copper tubing, extension 70 is made of ¾″ black pipe, sleeve 71 is made of a 2″ copper pipe tee, and air intake 74 is a ¾″ pipe tee. Alternatively, plastic tubing, pipe, and tees can be used, as can other materials (not necessarily tubing, pipes, and tees) of different sizes.

### Alternative Embodiments

The invention is in no way limited to the specifics of any particular embodiments and examples disclosed herein. For example, the terms “preferably,” “preferred embodiment,” “one embodiment,” “this embodiment,” “alternative embodiment,” “alternatively” and the like denote features that are preferable but not essential to include in embodiments of the invention. All given specific examples (i.e., “for example” or “e.g.”) are illustrative and not limiting. In addition, each of the features discussed in reference to any of the figures can be used with or instead of any features discussed with reference to any of the other figures. Many other variations are possible which remain within the content, scope and spirit of the invention, and these variations would become clear to those skilled in the art after perusal of this application.

What is claimed is:

1. A swiveling overhead air supply for an air powered tool, comprising:
a mounting structure;
a swivel attached to or incorporated into the mounting structure;
an arm attached to the swivel; and
an air line or air line connector attached to, hanging down from, or extending from the arm.

2. The swiveling overhead air supply as in claim 1, wherein the air line or air line connector is located at or near an end of the arm opposite the swivel.

3. The swiveling overhead air supply as in claim 1, wherein the mounting structure mounts to a ceiling, a beam in the ceiling, a wall, or a beam in the wall.

4. The swiveling overhead air supply as in claim 3, wherein the mounting structure comprises at least one plate and one or more bolts that bolt the plate to the ceiling, the beam in the ceiling, the wall, or the beam in the wall.

5. The swiveling overhead air supply as in claim 3, wherein the mounting structure comprises at least one clamp that clamps to the ceiling, the beam in the ceiling, the wall, or the beam in the wall.

6. The swiveling overhead air supply as in claim 3, wherein the mounting structure comprises at least one U-bolt that bolts to the ceiling, the beam in the ceiling, the wall, or the beam in the wall.

7. The swiveling overhead air supply as in claim 1, wherein the swivel comprises a bearing housing within a sleeve and one or more bearings and/or bushings that permit the bearing housing to rotate within the sleeve.

8. The swiveling overhead air supply as in claim 1, wherein the arm is at least three feet long.

9. The swiveling overhead air supply as in claim 1, wherein the arm is at least six feet long.

10. The swiveling overhear air supply as in claim 1, wherein air flows through the swivel, the arm, or both to the air line or air line connector.

11. The swiveling overhead air supply as in claim 1, further comprising an internal air line that runs at least partially within the swivel, the arm, or both to form or to attach to the air line or the air line connector.

12. The swiveling overhead air supply as in claim 1, further comprising an external air line that runs at least partially along the mounting structure, the swivel, and the arm to form or to attach to the air line or the air line connector.

13. The swiveling overhead air supply as in claim 1, further comprising a retracting housing attached to the arm, the retracting housing for the air line or for an external air line attached to the air line connector.

14. A method of providing an air supply for an air powered tool, comprising:
mouting swiveling overhead air supply overhead, the swiveling overhead air supply comprising a mounting structure, a swivel attached to or incorporated into the mounting structure, an arm attached to the swivel, and an air line or air line connector attached to, handing down from, or extending from the arm; and
supplying air through the swiveling overhead air supply to the air line or air line connector.

15. The method as in claim 14, wherein the air line or air line connector is located at or near an end of the arm opposite the swivel.

16. The method as in claim 14, wherein swiveling overhead air supply is mounted to a ceiling, a beam in the ceiling, a wall, or a beam in the wall.

17. The method as in claim 16, wherein the mounting structure comprises at least one plate and one or more bolts that bolt the plate to the ceiling, the beam in the ceiling, the wall, or the beam in the wall.

18. The method as in claim 16, wherein the mounting structure comprises at least one clamp that clamps to the ceiling, the beam in the ceiling, the wall, or the beam in the wall.

19. The method as in claim 16, wherein the mounting structure comprises at least one U-bolt that bolts to the ceiling, the beam in the ceiling, the wall, or the beam in the wall.

20. The method as in claim 14, wherein the swivel comprises a bearing housing within a sleeve and one or more bearings and/or bushings that permit the bearing housing to rotate within the sleeve.

21. The method as in claim 14, wherein the arm is at least three feet long.

22. The method as in claim 14, wherein the arm is at least six feet long.

23. The method as in claim 14, wherein air flows through the swivel, the arm, or both to the air line or air line connector.

24. The method as in claim 14, wherein the swiveling overhead air supply further comprises an internal air line that runs at least partially within the swivel, the arm, or both to form or to attach to the air line or the air line connector.

25. The method as in claim 14, wherein the swiveling overhead air supply further comprises an external air line that runs at least partially along the mounting structure, the swivel, and the arm to form or to attach to the air line or the air line connector.

26. The method as in claim 14, wherein the swiveling overhead air supply further comprises a retracting housing attached to the arm, the retracting housing for the air line or for an external air line attached to the air line connector.
